(19) United States
(12) Patent Application Publication
(10) Pub. No.: US 2025/0342984 A1
(43) Pub. Date: Nov. 6, 2025

(54) ULTRASONICALLY BONDED PERMANENT NODES BETWEEN A FEEDER AND A MULTIPLICITY OF CONDUCTORS

(71) Applicants: Doug McCabe, Sacramento, CA (US); Kevin Austin, Galt, CA (US); Kurt Odra, Sacramento, CA (US)

(72) Inventors: Doug McCabe, Sacramento, CA (US); Kevin Austin, Galt, CA (US); Kurt Odra, Sacramento, CA (US)

(21) Appl. No.: 19/267,417

(22) Filed: Jul. 11, 2025

Related U.S. Application Data
(63) Continuation of application No. 16/739,021, filed on Jan. 9, 2020.

(51) Int. Cl. H01B 7/00; H01R 4/02; H01R 4/70; H01R 43/02

(52) U.S. Cl. CPC H01B 7/009; H01R 4/021; H01R 43/0207; H01R 4/70

(57) ABSTRACT

An ultrasonically bonded permanent node comprises at least one feeder, a plurality of parallel conductors physically and electrically coupled to the feeder by ultrasonic bonding to form the node and an encasement positioned over the node to reduce and prevent electric flow outwardly from the node. The ultrasonic bonding allows physical and electrical coupling of the at least one feeder having a large size relative to the plurality of parallel conductors having a small size. A method for coupling the plurality of parallel conductors with the feeder comprises the steps of: removing the insulation of the feeder and each of the plurality of parallel conductors. Ultrasonically bonding the conductor of the feeder and the plurality of parallel conductors to create a node and positioning an encasement over the node to provide insulation to the exposed conductors.

### PRIORITY

This application is a continuation application of U.S. patent application Ser. No. 16/739,021 filed Jan. 9, 2020, and which claims priority from the United States provisional application having Ser. No. 62/790,402, filed Jan. 9, 2019. The disclosure of that provisional application is incorporated herein by reference as if set out in full.

### BACKGROUND OF THE DISCLOSURE

### Technical Field of the Disclosure

The present invention relates generally to electrical power distribution, and more specifically to a system and method for coupling distinguishable conductors of a power circuit extended and sub-divided at nodes through the solid state process of ultrasonic bonding.

### Description of the Related Art

Electrical power distribution system are networks of conductive paths, protective mechanisms, switches, etc. used to transfer electric current from an energy source, i.e., a power generator to a load, i.e., the point where the electricity is consumed or used to do work. Conventionally, the term refers to networks that are not within a consumer electronic device but rather in civil, building, or infrastructure that may service many devices or can be inter-device. Examples may include a utility grid or electrical wiring in a building that connects receptacle outlets to a power grid.

A power circuit interconnects two or more sub-systems in a power distribution system. They are typically engineered or used so that the characteristics of the power e.g., current, voltage, etc. at or between each system can be estimated during normal operating conditions. In its simplest form, a circuit can be a conductor that electrically couples two electrical systems.

Many power circuits have nodes or junctions where a conductor may be spliced or tapped. Splicing generally refers to physically and electrically coupling one conductor to another conductor at the physical ends to effectively extend the overall length of the circuit. Sometimes the spliced conductors may have different characteristics, e.g., one may be an aluminum alloy and the other a copper alloy, in which case, the splice may be employed due to economics or the requirements of the connection points in the circuit.

Tapping generally refers to physically and electrically coupling one conductor i.e. the feeder to one or more other conductors, the branches where the feeder may not be at its physical end and may be further tapped or spliced at other locations. The primary purpose of a tap is to create multiple sub-circuits or parallel electrical paths from a circuit. The branches may have different characteristics from the feeder based on the specific requirements of the sub-circuit that it services, e.g., the branch may have less power-carrying capacity than the feeder since less power is expected on the branch.

Power circuits with spliced or tapped nodes have existed throughout the history of power distribution applications and are essential to constructing power circuits. Generally, splices and taps are meant to be permanent and the associated conductors are permanently coupled. The term permanent is used here to convey indistinguishable movement or physical change during normal operation of the associated circuit. i.e., the characteristics of the node should not change unless a human or human-controlled action is performed, and the node was constructed to be responsive to this action while preserving the safety or operability of the circuit. Additionally, the nodes are typically insulated, or the circuits operated in such a manner that the energies at the nodes do not transfer in a disruptive manner to adjacent systems, biology (including humans), or the environment during normal operation.

There are many means for performing a permanent splice or tap including the use of mechanical connectors based on torque, force (crimp), snap, etc. Some connectors are made of conductive material which is placed in physical contact with the conductors at the node and provides a path or pathways for power flow to/from the conductors via the connector. However, the conductors are not in direct physical contact with each other when in the connector. Moreover, the conductive material should have power carrying capacities equal to that of the total power transferred through the device, and should have impedance low enough as not to significantly impact the characteristics of the circuit more than intended at the node. Sufficient force is required at the contact between the connector and the conductors to permanently hold the conductors in place during normal operation and handling of the circuit. Conventional connectors use force to permanently physically couple the conductors so that they are in direct contact with each other such that the main power pathway is at the points where the conductors touch and not necessarily through the connector. The connector should allow for there to be enough surface area at the point of contact between the conductors so that the impedance at the node is insignificantly low. In most cases, these connectors are also made of conductive material.

Resistance spot welding or arc welding is also a means of splicing or tapping power circuits. This welding technology is widely used in the manufacturing industry for joining metal sheets and components. The weld is made by conducting a strong current through the metal combination to heat up and ultimately melt the metals at localized point(s) predetermined by the design of the electrodes and/or the work-pieces to be welded. In these cases, material foreign to the conductors is not introduced at the point of coupling, instead pressure and electric current are used to generate heat which melts both conductors to form a joint that is electrically (that is, low impedance) and physically sound. However, with this approach, the conductor with significantly larger cross-sectional areas cannot be spliced or tapped with conductors of significantly less cross-sectional. Moreover, the limitations with this approach is that it requires sophisticated equipment having high power consumption and cooling requirements in order to perform permanent splices or taps where only small surface areas are available. Additionally, high precision is needed to prevent heat damage to insulation that may be present on the conductors downstream/upstream of the splice or tap point.

There is thus a need for a bonded permanent node and a method for coupling distinguishable conductors extended and sub-divided at nodes through the solid state process of ultrasonic bonding. Such an ultrasonically bonded permanent node allows conductors with significantly larger cross-sectional areas to be spliced or tapped with conductors of significantly less cross-sectional area. Such a coupling method would allow permanent splicing or tapping of power circuits without utilizing a foreign material or mechanical means (crimping). Such an ultrasonically bonded permanent node would allow the bonding of conductors having a cross-sectional area above 0.03 square inches. Such a coupling would not require mechanical connectors made of conductive material to provide physical contact with the conductors. Such a coupling would provide direct contact with the conductors being connected. Such a coupling method would not require additional force to permanently hold the conductors in place during normal operation and handling of the circuit. Such a coupling method does not require sophisticated equipment having high power consumption and cooling requirements. The present embodiment overcomes shortcomings in the field by accomplishing these critical objectives.

### SUMMARY OF THE DISCLOSURE

To minimize the limitations found in the existing systems and methods, and to minimize other limitations that will be apparent upon the reading of the specifications, a preferred embodiment of the present invention provides an ultrasonically bonded permanent node and a method for coupling distinguishable conductors of a circuit extended and sub-divided at nodes through the solid state process of ultrasonic bonding.

The ultrasonically bonded permanent node comprises at least one feeder and a plurality of parallel conductors physically and electrically coupled to the feeder by ultrasonic bonding to form the node and an encasement positioned over the node to reduce and prevent electric flow outwardly from the node. The node may be bidirectional, or power may be supplied by the plurality of conductors. Critically, the ultrasonically created bond allows physical and electrical coupling of the at least one feeder having a large size with the plurality of conductors having a small size.

In the preferred embodiment, a single feeder is ultrasonically bonded to the plurality of parallel conductors. The plurality of conductors is significantly smaller than the feeder such that the cross-sectional areas of the conductive parts of each the plurality of conductors is significantly less than the cross-sectional area of the conductive part of the feeder. The ratio of the at least one feeder diameter to each of the plurality of conductors is preferably at least 2:1, but in alternative embodiments may be at least 3:1, 4:1, 5:1, 8:1, 10:1, 15:1, 20:1, or at least 40:1. Although no upper limit to the ratio is envisioned (that is, no limit to relative large size of the feeder to each conductor), however, in some embodiments the upper limit is either 40:1, 50:1, or 100:1.

Ultrasonic bonding is accomplished by introducing high-frequency vibration while the plurality of parallel conductors and the feeder are under moderately high clamping force. The feeder and the plurality of parallel conductors have an insulation layer over them. The insulation layer over the feeder and the plurality of parallel conductors are stripped off to expose a small section of bare conductors. The plurality of insulated parallel conductors are stripped to the bare conductor at one end and ultrasonically bonded to the bare feeder conductor at minimal bond area to create the node. The node thus created by the ultrasonic bonding has a size similar or within the same magnitude as to the sum of the cross-sectional areas of the plurality of conductors. The bare conductors are then encased in the encasement made of a material with insulation properties to reduce or prevent the flow of electricity outside of the node.

The method for coupling the plurality of parallel conductors to at least one feeder utilizing ultrasonically bonding comprises the steps of: removing the insulation of the feeder to expose the conductor of the feeder in a small section. Then removing the insulation of each of the plurality of parallel conductors in a small section. Ultrasonically bonding the conductor of the feeder and the plurality of parallel conductors to create a node and positioning an encasement over the node to provide insulation to the exposed conductors at the node and reduce the flow of electricity outside of the bonded node.

A first objective of the present embodiment is to provide an ultrasonically bonded permanent node and a method for coupling distinguishable conductors extended and sub-divided at nodes through the solid state process of ultrasonic bonding.

A second objective of the present embodiment is to provide an ultrasonically bonded permanent node that allows conductors with significantly larger cross-sectional areas to be spliced or tapped with conductors of significantly less cross-sectional area.

A third objective of the present embodiment is to provide a coupling method that allows permanent splicing or tapping of power circuits without utilizing an external mechanism.

A fourth objective of the present embodiment is to provide an ultrasonically bonded permanent node that allows bonding of conductors having a cross-sectional area above 0.03 square inches.

A fifth objective of the present embodiment is to provide a coupling that does not require mechanical connectors made of conductive material to provide physical contact with the conductors.

Another objective of the present embodiment is to provide a coupling that provides direct contact with the conductors being connected.

Yet another objective of the present embodiment is to provide a coupling method that does not require additional force to permanently hold the conductors in place during normal operation and handling of the circuit.

Still another objective of the present embodiment is to provide a coupling method that does not require sophisticated equipment having high power consumption and cooling requirements.

These and other advantages and features of the present invention are described with specificity so as to make the present invention understandable to one of ordinary skill in the art.

### BRIEF DESCRIPTION OF THE DRAWINGS

In order to enhance their clarity and improve the understanding of the various elements and embodiment, elements in the figures have not necessarily been drawn to scale. Furthermore, elements that are known to be common and well understood to those in the industry are not depicted in order to provide a clear view of the various embodiments of the invention. Thus, the drawings are generalized in form in the interest of clarity and conciseness.

FIG. 1A illustrates a side view of an ultrasonically bonded permanent node in accordance with the preferred embodiment of the present invention;

FIG. 1B illustrates an end view of the ultrasonically bonded permanent node in accordance with the preferred embodiment of the present invention;

FIG. 1C illustrates a side view of the ultrasonically bonded permanent node without an encasement in accordance with the preferred embodiment of the present invention;

FIG. 2 illustrates a side view of the ultrasonically bonded permanent node bonded with a pair of conductors in accordance with one embodiment of the present invention;

FIG. 3 illustrates a side view of an ultrasonically bonded permanent node in accordance with the alternate embodiment of the present invention;

FIG. 4 illustrates a side view of the ultrasonically bonded permanent node bonded with a pair of conductors in accordance with the alternate embodiment of the present invention;

FIG. 5 illustrates a side view of the ultrasonically bonded permanent node in accordance with the alternate embodiment of the present invention;

FIG. 6 illustrates a flowchart of a method for coupling a plurality of parallel conductors to at least one feeder utilizing ultrasonically bonding in accordance with the preferred embodiment of the present invention;

FIG. 7 illustrates a side view of an ultrasonically bonded permanent node in accordance with an additional alternate embodiment of the present invention; and

FIG. 8 illustrates a side view of the ultrasonically bonded permanent node bonded with a pair of conductors in accordance with an additional embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

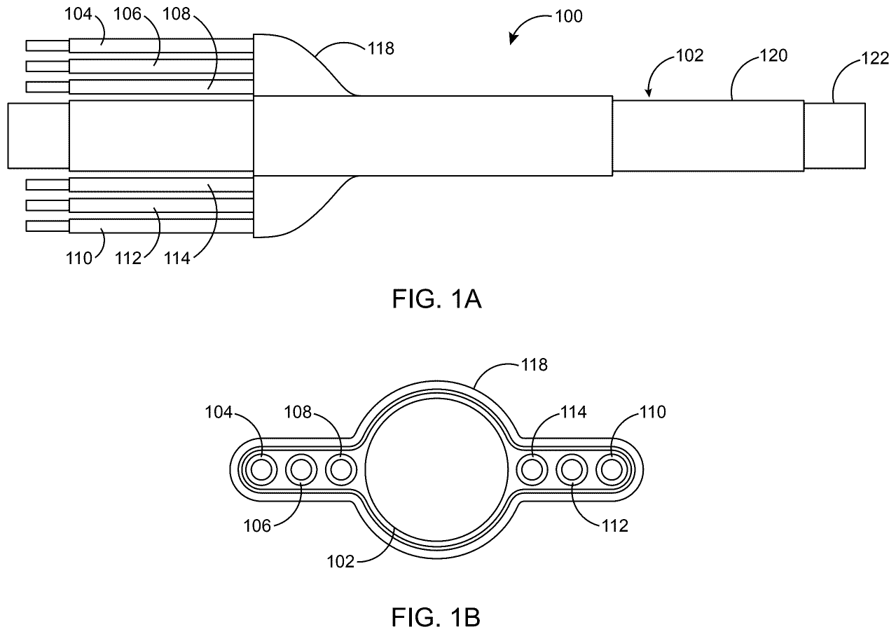

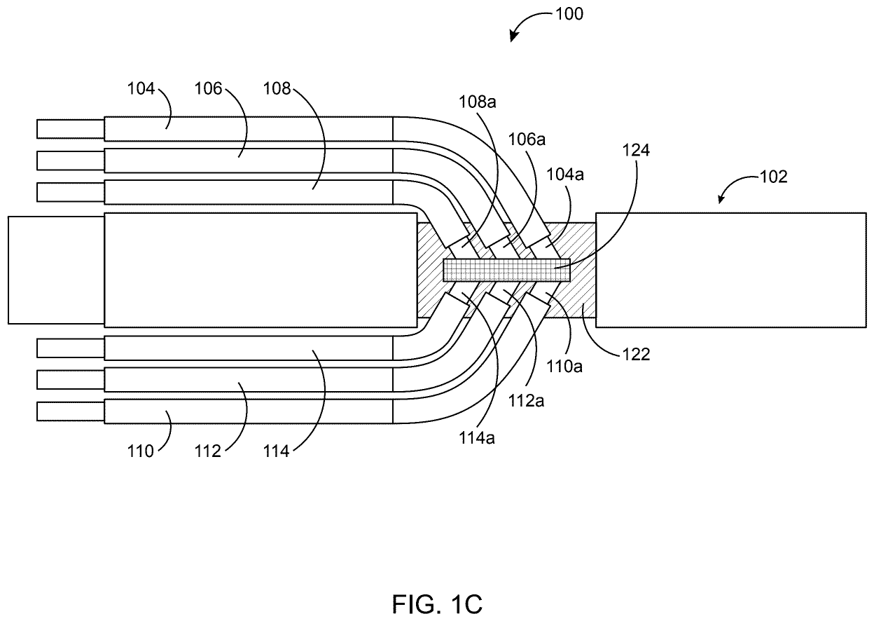

Referring to FIGS. 1A-1C, different views of an ultrasonically bonded permanent node 100 of a circuit in accordance with the preferred embodiment of the present invention are illustrated. The ultrasonically bonded permanent node 100 utilizes no foreign or outside mechanism to physically and electrically couple the distinguishable conductors—that is, only the materials of the feeder and conductor wires alone are used to create the bonded permanent node. The ultrasonically bonded permanent node 100 of the preferred embodiment comprises at least one feeder 102 and a plurality of parallel conductors 104, 106, 108, 110, 112 and 114 physically and electrically coupled to the feeder 102. Although in a preferred embodiment the system is bidirectional, in some embodiments the conductors provide the power to the feeder. The two are connected by ultrasonic bonding to form the node 100 and an encasement 118 is positioned over the node 100 to reduce and prevent electric flow outwardly from the node 100. The ultrasonic bonding of the present invention allows physical and electrical coupling of the at least one feeder 102 having a large size with the plurality of conductors 104, 106, 108, 110, 112 and 114 having a small size.

In the preferred embodiment, a single feeder 102 is ultrasonically bonded to the plurality of parallel conductors 104, 106, 108, 110, 112 and 114. The plurality of parallel conductors 104, 106, 108, 110, 112 and 114 are significantly smaller than the feeder 102 such that the cross-sectional areas of the conductive parts of each the plurality of parallel conductors 104, 106, 108, 110, 112 and 114 is significantly less than the cross-sectional area of the conductive part of the feeder 102. The sum of the cross-sectional areas of the plurality of parallel conductors 104, 106, 108, 110, 112 and 114 is distinguishably less than that of the cross-sectional area of the feeder 102. For example, the feeder 102 can have cross sectional areas larger than 0.03 square inches and the plurality of parallel conductors 104, 106, 108, 110, 112 and 114 can have cross sectional areas less than 0.03 square inches. The at least one feeder 102 has a size ranging from 6 AWG to 1000 MCM and the size of the plurality of parallel conductors 104, 106, 108, 110, 112 and 114 ranges from 12 AWG to 500 MCM. In some embodiments the feeder may be approximately the size of, or may range between any of the sizes of No. 6 AWG, 5 AWG, 4 AWG, 3 AWG, 2 AWG, 1 AWG, 0 AWG, 00 AWG, 000 AWG, 0000 AWG, 250 MCM, 300 MCM, 350 MCM, 400 MCM, 500 MCM, 600 MCM, 700 MCM, 800 MCM, 900 MCM, and 1000 MCM. In some embodiments the each of the plurality of parallel conductors may be approximately the size of, or may range between any of the sizes of 12 AWG, 11 AWG, 10 AWG, 9 AWG, 8 AWG, 7 AWG, 6 AWG, 5 AWG, 4 AWG, 3 AWG, 2 AWG, 1 AWG, 0 AWG, 00 AWG, 000 AWG, 0000 AWG, 250 MCM, 300 MCM, 350 MCM, 400 MCM, and 500 MCM.

In some embodiments, the number of the plurality of parallel conductors 104, 106, 108, 110, 112 and 114 ranges from 6 to 8 conductors, however, fewer or more conductors are available in alternative embodiments. The ratio of the at least one feeder 102 diameter to each of the plurality of parallel conductors 104, 106, 108, 110, 112 and 114 is preferably at least 2:1, but in alternative embodiments may be at least 3:1, 4:1, 5:1, 8:1, 10:1, 15:1, 20:1, or at least 40:1. Although no upper limit to the ratio is envisioned (that is, no limit to relative large size of the feeder to each conductor), however, in some embodiments the upper limit is either 40:1, 50:1, or 100:1. In certain embodiments, the feeder has a size ranging from 4.67 mm diameter to 25.4 mm diameter, and in some embodiments the conductor ranges in size from 2.052 mm diameter to 20.65 mm diameter.

As is known in the art, products known as ultrasonic metal welders do not actually weld metal. Instead, by introducing high-frequency vibration they create precise, solid-state metallurgical bonds without current, consumables or metal-melting temperatures. In the present invention, the high-frequency vibrations are imparted to the parallel conductors 104, 106, 108, 110, 112 and 114 and the feeder 102 while under moderately high clamping force. In the preferred embodiment illustrated in FIGS. 1A to 1C, the feeder 102 is bonded with, preferably, three parallel conductors on one side 104, 106, 108 and three parallel conductors 110, 112, 114 on the other side. The feeder 102 and the plurality of parallel conductors 104, 106, 108, 110, 112 and 114 have an insulation layer 120 over them. The insulation layer 120 over the feeder 102 and the plurality of parallel conductors 104, 106, 108, 110, 112 and 114 are stripped off, to expose a small section of bare conductors. The plurality of insulated parallel conductors 104, 106, 108, 110, 112 and 114 are stripped to form the bare conductor 104a, 106a, 108a, 110a, 112a and 114a at one end and ultrasonically bonded to the bare feeder conductor 122 at minimal bond area 124 to create the node 100. The node 100 thus created by the ultrasonic bonding has a size similar or within the same magnitude as to the sum of the cross-sectional areas of the plurality of parallel conductors 104, 106, 108, 110, 112 and 114. The node 100 exhibits minimal electrical resistance of less than one milli-ohm. The minimal bond area 124 near the node 100 is exposed with the bare conductors. To reduce or prevent the flow of electricity outside of the node 100, the bare conductors 104a, 106a, 108a, 110a, 112a, 114a and 122 are encased in the encasement 118 made of a material with insulation properties. The encasement 118 can have properties such as material types or thicknesses that reduce or prevent ingress of liquids e.g., water, dust, and other particulates into the exposed conductor areas near the minimal bond area 124. The encasement 118 can have properties that make it resistive to degradation due to radiation, e.g., from ultraviolet sources, flame or heat, excessively high or low ambient temperatures, heat produced by the feeders and branches during operation of the circuit, expansion and contraction of all the materials at the node due to temperature changes, etc.

In other embodiments, the electrical junction comprises at least one feeder to conduct electric current; a plurality of parallel conductors physically and electrically coupled to the feeder by ultrasonic bonding to form a node; and an encasement positioned over the node to limit electric current flow outwardly from the node; whereby the ultrasonic bonding allows physical and electrical coupling of the at least one feeder having a large diameter with the plurality of conductors having a small diameter, such that the at least one feeder diameter is at least two times the diameter of each of said conductors. In still other embodiments the ratio of the at least one feeder diameter to the diameter of each of the plurality of conductors is at least 4:1, or at least 10:1, or at least 20:1, or at least 50:1, or at least 100:1. In still other embodiments the ratio of the cross sectional area of the feeder to the cross sectional area of each of the conductors is at least 2:1, or at least 3:1, or at least 4:1, or at least 10:1, or at least 20:1, or at least 50:1, or at least 100:1, or some range between these values.

The encasement 118 can be partially filled or completely filled, or unfilled (hollow) i.e., providing only an exterior shell and may use any combination of materials that are typically nonconductive.

The present invention may include any number of the plurality of parallel conductors, and is not limited to the 6-branch node illustrated in FIGS. 1A-1C. For example, the system may incorporate 1-branch, 3-branch, 10-branch, more than 10-branch, and effectively n-branch.

The feeder 102 and the plurality of conductors 104, 106, 108, 110, 112 and 114 include any conductive material suitable for the applications of the circuit. For example, copper alloys including but not limited to tin or nickel-plated copper or specific aluminum alloys can be used in the device when applied to power distribution within buildings or infrastructure. The insulation 120 can also be of any insulation suitable for the applications of the circuit or based on the encasement 118 material.

The present embodiment may comprise strain reliefs (not shown) on the plurality of parallel conductors 104, 106, 108, 110, 112 and 114 applied within the encasement 118 to relieve physical strain on the point of physical coupling between each of the plurality of parallel conductors 104, 106, 108, 110, 112 and 114 and further solidify the permanence of the node 100.

The invention may be realized without the encasement 118 and strain reliefs (not shown) if the node 100 is within an environment where it is protected from the elements or biology or cannot alter the operation of other circuits or nodes that is exposed. For example, if the invention is realized totally within a cabinet with sufficient clearances between the exposed conductors and other electrified surfaces during operation may be provided for.

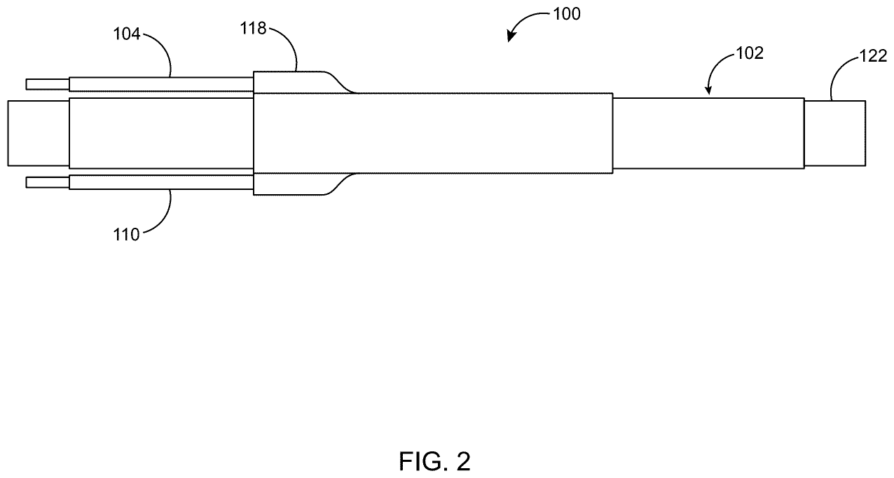

FIG. 2 illustrates a side view of the ultrasonically bonded permanent node bonded with a pair of conductors 104, 110 in accordance with one embodiment of the present invention. This embodiment includes one conductor 104 positioned on one side and another conductor 110 positioned on other side of the feeder 102. The pair of conductors 104, 110 is bonded to the feeder 102 utilizing ultrasonic bonding. The encasement 118 is positioned over the node 100 to prevent flow of electricity outwardly from the node 100.

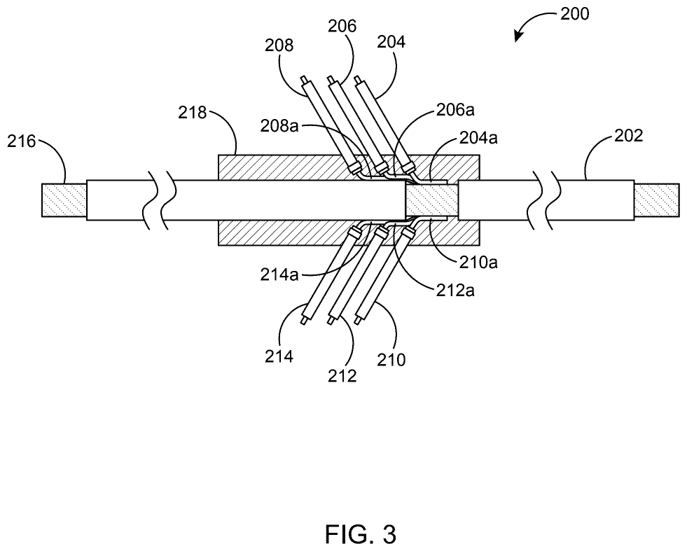

FIG. 3 illustrates a side view of an ultrasonically bonded permanent node 200 in accordance with an alternate embodiment of the present invention. In this embodiment, the ultrasonically bonded permanent node 200 comprises at least one feeder 202, a plurality of conductors 204, 206, 208, 210, 212 and 214 physically and electrically coupled to the feeder by ultrasonic bonding to form the node 200 and an encasement 218 positioned over the node 200 to reduce and prevent electric flow outwardly from the node 200. The plurality of conductors 204, 206, 208, 210, 212 and 214 is coupled at an angle with the at least one feeder 202 and not held in parallel.

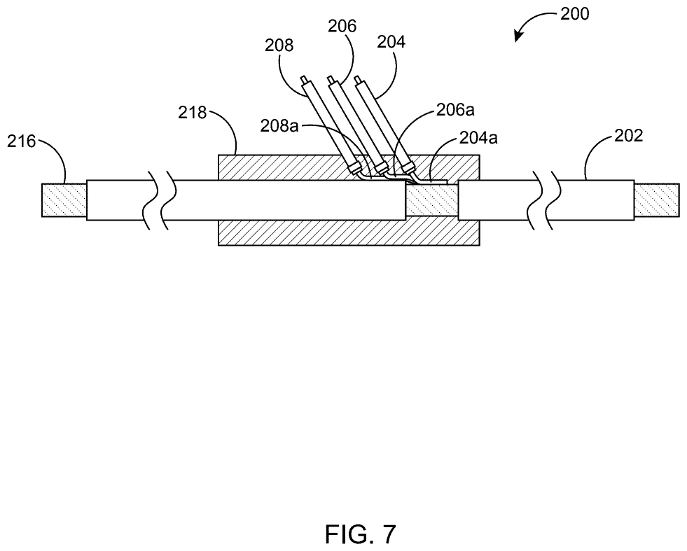

In this embodiment, as illustrated in FIG. 3, the feeder 202 is bonded with, preferably, three conductors 204, 206, 208 on one side and three conductors 210, 212, 214 on the other side. The insulation layer over the feeder 202 and the plurality of conductors 204, 206, 208, 210, 212 and 214 are stripped off, to expose a small section of bare conductors. The plurality of conductors 204, 206, 208, 210, 212 and 214 are stripped to the bare conductors 204a, 206a, 208a, 210a, 212a and 214a at one end and ultrasonically bonded to the bare feeder conductor 216 to create the node 200. The bare conductors 204a, 206a, 208a, 210a, 212a, 214a and 216 are encased in the encasement 218 made of a material with insulation properties to reduce or prevent the flow of electricity outside of the node 200. An alternative embodiment to FIG. 3 is shown at FIG. 7 wherein the plurality of connectors is three.

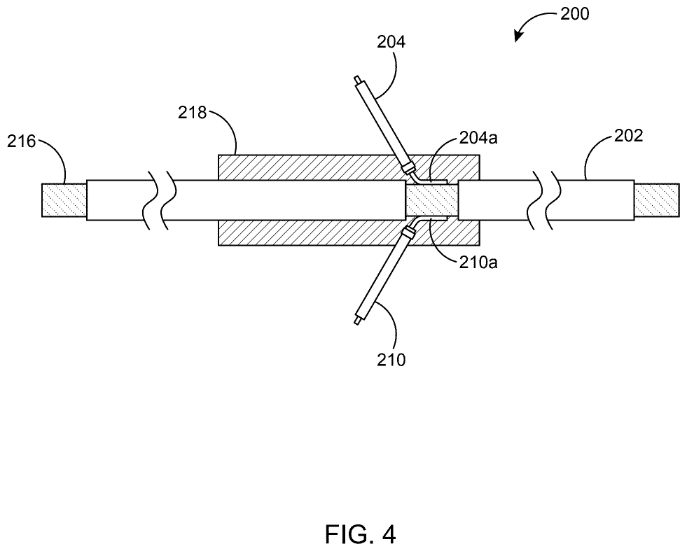

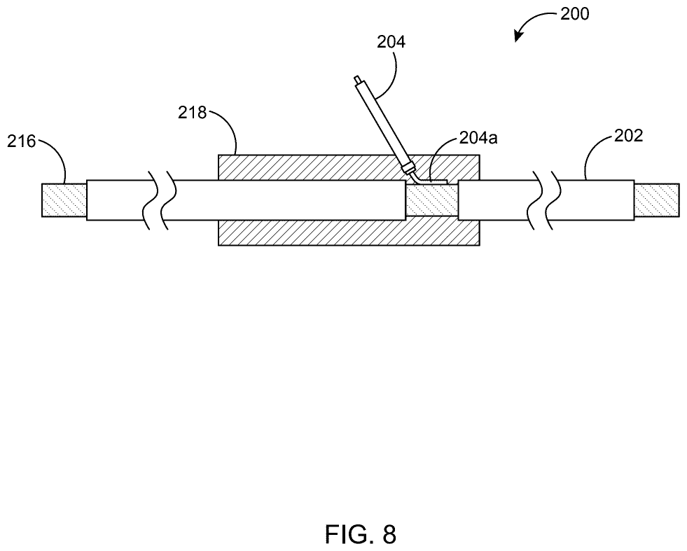

FIG. 4 illustrates a side view of the ultrasonically bonded permanent node 200 bonded with a pair of conductors 204, 210 in accordance with the alternate embodiment of the present invention. This embodiment includes one conductor 204 positioned on one side and another conductor 210 positioned on other side at an angle with the feeder 202 and bonded utilizing ultrasonic bonding. The encasement 218 is positioned over the node 200 to prevent flow of electricity outwardly from the node 200. An alternative embodiment to FIG. 4 is shown at FIG. 8 wherein the plurality of connectors is one.

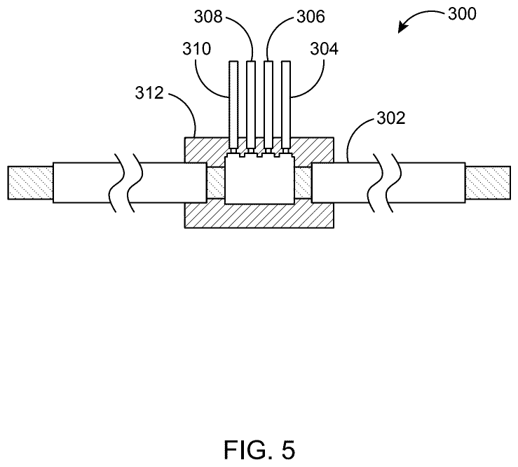

FIG. 5 illustrates a side view of the ultrasonically bonded permanent node 300 in accordance with the alternate embodiment of the present invention. In this embodiment, the plurality of conductors 304, 306, 308 and 310 is ultrasonically coupled perpendicularly with respect to the feeder 302. The insulation 312 on each of the plurality of conductors 304, 306, 308 and 310 is removed at one end and is ultrasonically bonded to the feeder 302 un-insulated at the point of the bond.

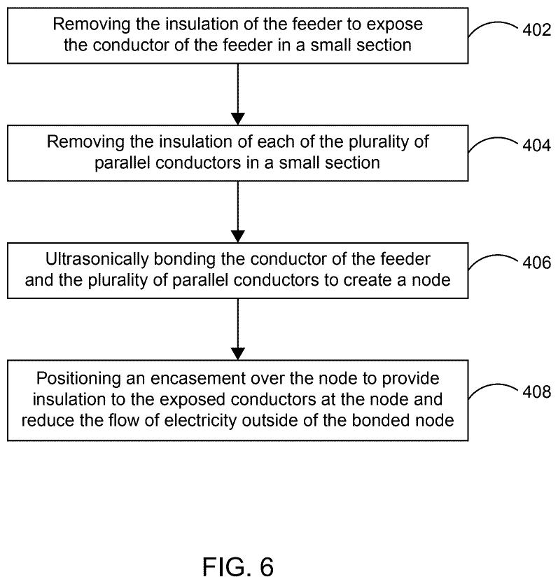

FIG. 6 illustrates flowchart of a method for coupling a plurality of parallel conductors to at least one feeder utilizing ultrasonically bonding in accordance with the preferred embodiment of the present invention. The method comprises the steps of: removing the insulation of the feeder to expose the conductor of the feeder in a small section as indicated at block 402. Then removing the insulation of each of the plurality of parallel conductors in a small section as indicated at block 404. Ultrasonically bonding the conductor of the feeder and the plurality of parallel conductors to create a node as indicated at block 406 and positioning an encasement over the node to provide insulation to the exposed conductors at the node and reduce the flow of electricity outside of the bonded node as indicated at block 408.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. An ultrasonically bonded electrical node, comprising:
a. a feeder conductor having a first exposed conductive portion;
b. a plurality of branch conductors, each having a second exposed conductive portion, and each having a cross-sectional area smaller than that of the feeder conductor;
c. a layered ultrasonic bond region wherein the plurality of branch conductors are arranged adjacent each other and directly ultrasonically bonded to the feeder conductor without use of intermediate lugs, clamps, or inserts; and
d. an electrically insulating encasement formed over the bonded region to prevent the ingress of water, wherein the encasement comprises a molded or cured body configured to maintain fixed conductor orientation.

2. The node of claim 1 wherein the encasement provides a compressive sealing force across the bonded region.

3. The node of claim 1, wherein the plurality of branch conductors are held in a serpentine layout across the surface of the feeder conductor to promote distributed bonding.

4. The node of claim 1, wherein the ultrasonic bond region has an effective ultrasonic bonding surface area approximately equal to or greater than the combined cross-sectional area of the plurality of branch conductors.

5. A method of forming a permanent electrical junction, comprising:
a. exposing a conductive portion of a feeder conductor and of each of a plurality of branch conductors;
b. arranging the plurality of branch conductors in contact with the feeder conductor in a layered configuration along a bonding axis;
c. ultrasonically bonding the feeder conductor and the branch conductors together using only the native materials of the conductors, without mechanical inserts or lugs; and
d. applying a insulating material over the bonded conductors and curing the material in place to form a sealed encasement that maintains the spatial geometry of the conductors during post-installation use.

6. The method of claim 5, further comprising positioning a pre-formed insulating encasement over the node to provide electrical isolation and reduce lateral electric discharge.

7. The method of claim 5, further comprising placing a compression fixture over the conductors during curing to maintain conductor orientation.

8. The method of claim 5, wherein the step of ultrasonically bonding comprises simultaneously bonding three or more parallel conductors to the feeder in a side-by-side configuration.

9. The method of claim 8, wherein the feeder conductor has a cross-sectional area at least five times greater than that of any of the parallel conductors.

10. A prefabricated conductor harness for electrical field installation, comprising:
a. a bundled assembly of electrical conductors including:
i. a feeder conductor with an exposed bonding portion; and
ii. a plurality of branch conductors arranged in a predefined layout for bonding to the feeder conductor;
b. an ultrasonically bonded node formed between the feeder conductor and the plurality of branch conductors at the exposed bonding portion;
c. an insulating overmold encasing the bonded region; and
d. wherein each of the plurality of branch conductors exits the overmold in a non-parallel manner relative to the feeder conductor.

11. The prefabricated conductor harness of claim 10, wherein the feeder conductor is configured to remain continuous through the node, and the plurality of conductors are tapped to the outer surface.

12. The prefabricated conductor harness of claim 10, wherein the plurality of parallel conductors extends out of the node at an angle other than parallel to the feeder.

13. The prefabricated conductor harness of claim 10, wherein the bonded region couples the feeder to at least six conductors, the six conductors having a combined total cross-sectional area less than half of the feeder's cross-sectional area.

14. An electrical distribution system, comprising:
a. a power source configured to output electrical current;
b. a feeder conductor electrically connected to the power source; and
c. a plurality of branch conductors coupled to the feeder conductor via an ultrasonically bonded node, the branch conductors comprising a segment with a stepped radial increase in cross-sectional diameter, wherein the transition between the standard diameter and the increased diameter occurs via substantially orthogonal annular walls relative to the wire's longitudinal axis;
d. wherein the ultrasonically bonded node comprising an ultrasonic bond formed directly between the feeder conductor and the plurality of branch conductors and an electrically insulating molded encasement surrounding the bonded region.

15. The electrical distribution system of claim 14 wherein each of the plurality of branch conductors exits the overmold in a non-parallel manner relative to the feeder conductor.

16. The electrical distribution system of claim 14, wherein the bonded conductors are oriented such that the centerlines of the branch conductors deviate from the longitudinal axis of the feeder by at least 30 degrees.

17. The electrical distribution system of claim 14, wherein the stepped radial increase in cross-sectional diameter of each branch conductor provides an effective ultrasonic bonding surface area at least twice that of the standard diameter segment.

18. The electrical distribution system of claim 14, wherein the feeder conductor has a cross-sectional area of at least 250 MCM, and each branch conductor has a cross-sectional area of at least 12 AWG.

19. A prefabricated conductor harness for electrical field installation, comprising:
a. a bundled assembly of electrical conductors including:
i. a feeder conductor with an exposed bonding portion; and
ii. a plurality of branch conductors, each of the branch conductors having a longitudinal axis and a diameter, the branch conductors comprising a region of increased diameter positioned along the longitudinal axis, the region of increased diameter defined by opposing annular shoulders extending substantially perpendicular to the longitudinal axis, such that the wire diameter increases abruptly at said shoulders to form a step-like profile;
b. an ultrasonically bonded node formed between the feeder conductor and the plurality of branch conductors at the exposed bonding portion; and
c. an insulating overmold encasing the bonded region.

20. The prefabricated conductor harness of claim 19, wherein the region of increased diameter on each branch conductor has a diameter at least 1.5 times greater than the standard conductor diameter.

21. The prefabricated conductor harness of claim 19, wherein the feeder conductor has a cross-sectional area of at least 250 MCM, and each branch conductor has a cross-sectional area of at least 12 AWG.

22. The refabricated conductor harness of claim 19, wherein the conductors are bonded with an orientation such that the centerlines of the branch conductors deviate from the longitudinal axis of the feeder by at least 30 degrees.
